(19) United States
(12) Patent Application Publication
(10) Pub. No.: US 2005/0247529 A1
(43) Pub. Date: Nov. 10, 2005

(54) Aircraft brake acuation system including an internally threaded ballscrew actuator assembly

(76) Inventors: Louie T. Gaines, Phoenix, AZ (US); Kellan P. Geck, Chandler, AZ (US); James N. Quitmeyer, Chandler, AZ (US)

Correspondence Address: HONEYWELL INTERNATIONAL, INC., Law Dept. AB2, P.O. Box 2245, Morristown, NJ, 07962-9806, US

(21) Appl. No.: 10/954,822

(22) Filed: Sep. 29, 2004

Related U.S. Application Data
(60) Provisional application No. 60/568,894, filed on May 7, 2004.

(51) Int. Cl. F16D 55/08

(52) U.S. Cl. 188/72.8; 188/156

(57) ABSTRACT

An aircraft brake actuation system includes an actuator for selectively supplying a commanded brake force to one or more aircraft wheels. The actuator includes a ballscrew, a ballnut, and a plurality of balls. The ballscrew has a plurality of ball grooves formed on its inner surface, and is coupled to receive a rotational drive force. The ballnut is mounted against rotation, is disposed at least partially within the ballscrew, and includes a plurality of ball grooves formed on its outer surface. The plurality of balls are disposed within the ballnut ball grooves and at least selected ones of the ballscrew ball grooves.

### CROSS-REFERENCES TO RELATED APPLICATIONS

This application claims the benefit of U.S. Provisional Application No. 60/568,894, filed May 7, 2004.

### TECHNICAL FIELD

The present invention relates to aircraft brake actuation systems and, more particularly, to a brake actuation system including electromechanical actuator assemblies that use internally threaded ballscrews.

### BACKGROUND

When a jet-powered aircraft lands, the aircraft brakes, various aerodynamic drag sources (e.g., flaps, spoilers, etc.), and, in many instances, aircraft thrust reversers, are used to slow the aircraft down in the desired amount of runway distance. Once the aircraft is sufficiently slowed, and is taxiing from the runway toward its ground destination, the aircraft brakes are used slow the aircraft, and bring it to a stop at its final ground destination.

Presently, many aircraft brake systems include a plurality of hydraulic, pneumatic, or electromechanical actuators, and a plurality of wheel mounted brakes. The brakes in many aircraft are implemented as multi-disk brakes, which include a plurality of stator disks and rotor disks. The stator disks and rotor disks may be alternately splined to a torque tube or wheel rim, and disposed parallel to one another, to form a brake disk packet. The actuators, in response to an appropriate pilot-initiated command, move between an engage position and a disengage position. In the engage position, the actuators each engage a brake disk packet, moving the brake disks into engagement with one another, to thereby generate the desired braking force.

As was noted above, the actuators used in some aircraft brake systems may be electromechanical actuators. An electromechanical actuator typically includes an electric motor and an actuator. The electric motor may supply a rotational drive force to the actuator, which converts the rotational drive force to translational motion, and thereby translate, for example, between a brake engage position and a brake disengage position. Although various types of actuators may be used to implement an electromechanical actuator, many times a ballscrew actuator assembly is used.

As is generally known, a ballscrew actuator assembly typically includes an inner, externally-threaded ballscrew, and an external, internally-threaded ballnut. A plurality of balls are disposed in the threads between the ballscrew and ballnut. A ballscrew actuator may convert a rotational drive force to translational motion in one of two ways, depending upon its configuration. In a first configuration, the ballscrew is configured to rotate and receives the rotational drive force from the motor, and the ballnut is anti-rotated. Thus, upon receipt of the rotational drive force, the ballscrew will rotate and the ballnut will translate. In a second configuration, the ballscrew is configured to translate, and the ballnut, while being fixed axially, is configured to rotate and receives the rotational drive force from the motor. Thus, upon receipt of the rotational drive force, the ballnut will rotate and the ballscrew will translate.

Although the first and second ballscrew actuator assembly configurations operate well, and are generally safe, reliable, and robust, each configuration suffers certain drawbacks. For example, with the first configuration the motor, or other rotational drive source, may be supplied to an end of the ballscrew, which can increase the overall length of the actuator assembly. With the second configuration, the rotational drive force may be supplied to the ballnut at any one of numerous locations along its length, but the resultant motion of the ballscrew can result in the need to seal a surface that both rotates and translates. Moreover, with both configurations, the ballscrew may also be exposed to a potentially adverse environment. For example, in the context of an aircraft brake system, various amounts and types of dust, debris, and/or other particulate can be generated during aircraft and brake system operation. These potential contaminants can adversely affect actuator assembly operation, reduce component life, increase maintenance frequency, and/or increase overall system costs.

Hence, there is a need for a ballscrew actuator assembly, that may be used in an aircraft brake system, that addresses one or more of the above-noted drawbacks. Namely, a ballscrew actuator assembly that has a reduced size envelope relative to current ballscrew actuator assemblies, and/or does not require a surface that both rotates and translates to be sealed, and/or exhibits a relatively reduced adverse impact if exposed to dust, debris, and/or other particulate contaminants. The present invention addresses one or more of these needs.

### BRIEF SUMMARY

The present invention provides an aircraft brake actuation system that includes an actuator ballscrew actuator assembly having internal threads, which provides a relatively shorter overall length and increased capacity, as compared to known ballscrew actuator assemblies.

In one embodiment, and by way of example only, an aircraft brake actuation system includes a control circuit, a motor, and an actuator, the control circuit is configured to selectively supply brake force motor command signals representative of a commanded brake force. The motor is coupled to receive the brake force motor command signals from the control circuit and is operable, in response thereto, to supply a rotational drive force. The actuator is coupled to receive the rotational drive force from the motor and is configured, upon receipt thereof, to move to a position that corresponds to the commanded brake force. The actuator includes an actuator housing, a ballscrew, a ballnut, and a plurality of balls. The ballscrew is rotationally mounted within the actuator housing and includes at least an inner surface and an outer surface. The ballscrew inner surface has a plurality of ball grooves formed thereon. The ballscrew outer surface is coupled to receive the rotational drive force from the motor and is configured, in response thereto, to rotate. The ballnut is mounted against rotation and is disposed at least partially within the ballscrew. The ballnut includes at least an inner surface and an outer surface, and the ballnut outer surface has a plurality of ball grooves formed thereon. The plurality of balls are disposed within the ballnut ball grooves and at least selected ones of the ballscrew ball grooves.

In another exemplary embodiment, an actuator assembly includes a housing, a motor, a ballscrew, a ballnut, and a plurality of balls. The motor is configured to supply a rotational drive force. The ballscrew is rotationally mounted within the actuator housing and includes at least an inner surface and an outer surface. The ballscrew inner surface has a plurality of ball grooves formed thereon. The ballscrew outer surface is coupled to receive the rotational drive force from the motor and is configured, in response thereto, to rotate. The ballnut is mounted against rotation and is disposed at least partially within the ballscrew. The ballnut includes at least an inner surface and an outer surface, and the ballnut outer surface has a plurality of ball grooves formed thereon. The plurality of balls are disposed within the ballnut ball grooves and at least selected ones of the ballscrew ball grooves.

In yet another exemplary embodiment, an actuator includes a housing, a ballscrew, a ballnut, and a plurality of balls. The ballscrew is rotationally mounted within the actuator housing and includes at least an inner surface and an outer surface. The ballscrew inner surface has a plurality of ball grooves formed thereon. The ballscrew outer surface is adapted to receive a rotational drive force. The ballnut is mounted against rotation and is disposed at least partially within the ballscrew. The ballnut includes at least an inner surface and an outer surface, and the ballnut outer surface has a plurality of ball grooves formed thereon. The plurality of balls are disposed within the ballnut ball grooves and at least selected ones of the ballscrew ball grooves.

Other independent features and advantages of the preferred brake actuation system and actuator will become apparent from the following detailed description, taken in conjunction with the accompanying drawings which illustrate, by way of example, the principles of the invention.

### BRIEF DESCRIPTION OF THE DRAWINGS

FIG. 1 is a functional block diagram of an exemplary aircraft brake actuation system;

FIG. 2 is a perspective view of a physical implementation of a particular embodiment of a brake actuator assembly that may be used in the system of FIG. 1;

FIG. 3 is an end view of the brake actuator assembly shown in FIG. 2; and

FIGS. 4-7 are cross section views of the brake actuator assembly shown in FIG. 2, taken along lines 4-4, 5-5, 6-6, and 7-7, respectively, in FIG. 3.

### DETAILED DESCRIPTION OF A PREFERRED EMBODIMENT

The following detailed description is merely exemplary in nature and is not intended to limit the invention or the application and uses of the invention. Furthermore, there is no intention to be bound by any theory presented in the preceding background of the invention or the following detailed description of the invention. In this regard, before proceeding with the detailed description, it is to be appreciated that the described embodiment is not limited to use in conjunction with a specific vehicle or brake system. Thus, although the description is explicitly directed toward an embodiment that is implemented in an aircraft brake actuation system, it should be appreciated that it can be implemented in other vehicles and other brake actuation system designs, including those known now or hereafter in the art.

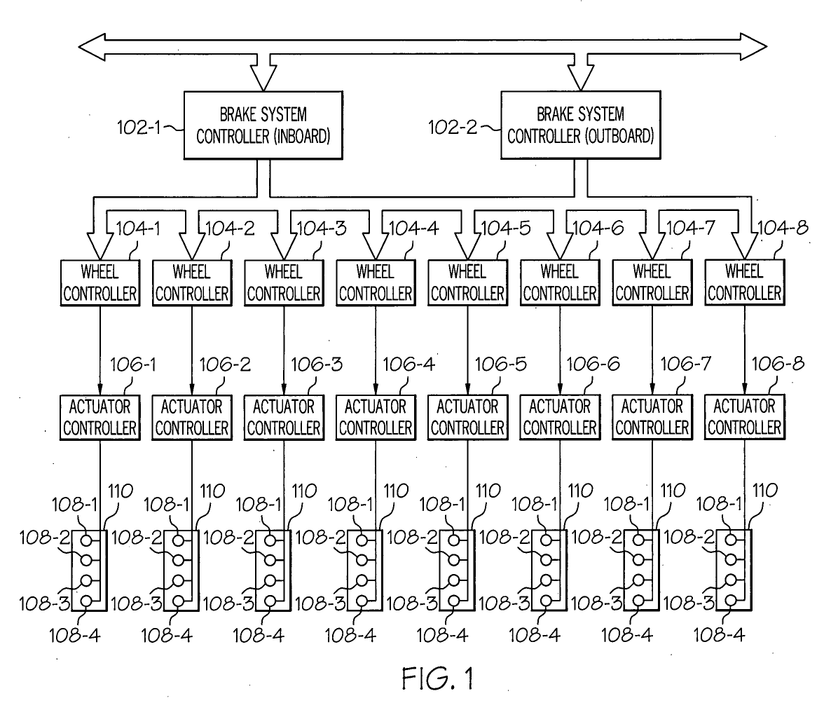

Turning now to the description, and with reference first to FIG. 1, a functional block diagram of an exemplary aircraft brake actuation system 100 is shown. In the depicted embodiment, the system 100 includes a plurality of brake system controllers 102, a plurality of wheel controllers 104, a plurality of actuator controllers 106, and a plurality of brake actuators 108. To provide redundancy, the system 100 includes two brake system controllers 102, an inboard brake system controller 102-1, and an outboard brake system controller 102-2, though it will be appreciated that it could include more than this number. Each brake system controller 102 receives brake command signals from, for example, brake pedal transducers (not shown) located in an aircraft cockpit (also not shown), which are representative of a desired brake force. The brake system controllers 102 are each configured to process the brake command signals from the transducers, and supply brake processed command signals to each of the wheel controllers 104.

The wheel controllers 104 are each coupled to receive the processed brake command signals supplied from each brake system controller 102 and are operable, in response to the received commands, to supply brake force command signals that are also representative of the desired brake force. In the depicted embodiment, the system 100 includes eight wheel controllers 104-1 through 104-8, though it will be appreciated that it could include more or less than this number depending, for example, on the number of wheels on the vehicle that are to be braked. No matter the specific number of wheel controllers 104 that are used, each wheel controller 104 supplies brake force command signals to one of the actuator controllers 106.

In the depicted embodiment, the system includes eight actuator controllers 106-1 through 106-8, one for each wheel controller 104. It will be appreciated, however, that this is merely exemplary and that the system 100 could be implemented with more or less than this number of actuator controllers 106. In any case, each actuator controller 106, in response to the brake force command signals it receives, supplies brake force actuator command signals to one or more brake actuators 108. It will be appreciated that the brake force actuator command signals, similar to the brake command signals and the brake force command signals, are representative of the desired brake force.

In response to the brake force actuator command signals, each actuator 108 moves to a position that corresponds to the commanded brake force, to thereby supply the desired brake force to a wheel 110. In the depicted embodiment, the system 100 is configured to be used with an aircraft that includes up to eight wheels 110, with four brake actuators 108-1, 108-2, 108-3, 108-4 per wheel 110 supplying the commanded brake force thereto. Thus, the system 100 may include up to a total of thirty-two brake actuators 108. It will be appreciated that this is merely exemplary of a particular embodiment, and that the system 100 could be configured to include more or less than this number of brake actuators 108.

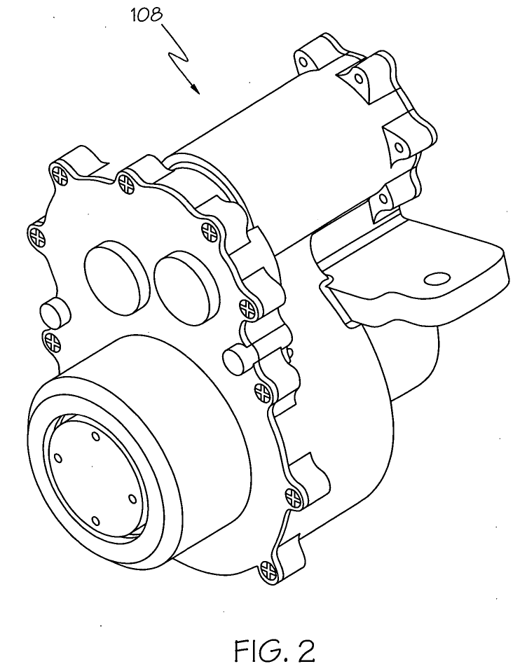

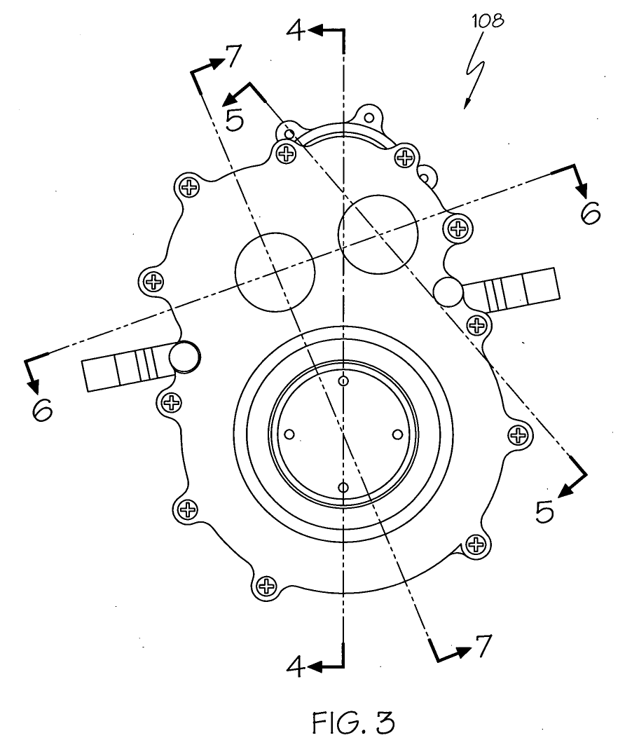

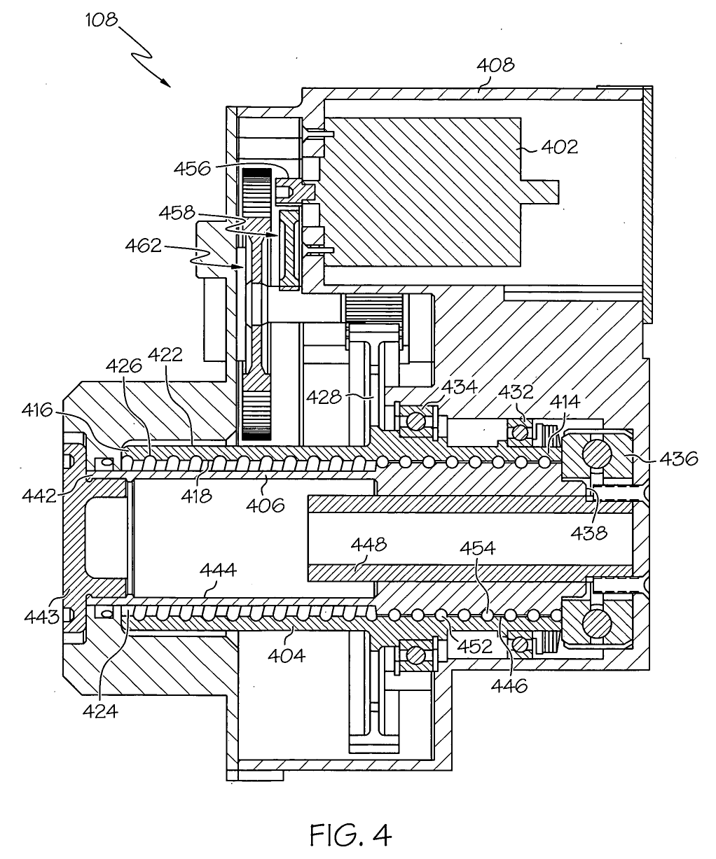

Turning now to FIGS. 2-7, a particular preferred embodiment of the brake actuator 108 that is used with the system 100 will now be described in more detail. A perspective view and an end view of a physical implementation of a particular embodiment of the brake actuator 108 are shown in FIGS. 2 and 3, respectively. As shown in FIG. 4, which is a cross section view taken along line 4-4 in FIG. 3, the depicted actuator 108 includes a motor 402, a ballscrew 404, and a ballnut 406, all preferably disposed within a single actuator housing assembly 408. The motor 402 receives the brake force actuator command signals from one of the actuator controllers 108 and, in response, rotates in the commanded direction to supply a rotational drive force. The motor 402 may be any one of numerous types of motors including, for example, hydraulic, pneumatic, and electric motors, the motor 202 is preferably an electric motor. Moreover, although the motor 402 may be implemented as any on of numerous types of electric motors, in a particular preferred embodiment, it is implemented as a brushless DC motor. No matter the particular type of motor 402 that is used, the rotational drive force supplied thereby is used to rotate the ballscrew 404. As will be described in more detail further below, in the depicted embodiment the rotational drive force is supplied to the ballscrew 404 via a plurality of gears.

The ballscrew 404 is rotationally mounted within the housing assembly 408, and includes a first end 414, a second end 416, an inner surface 418, and an outer surface 422. The ballscrew inner surface 418 defines a substantially cylindrical passageway 424 through the ballscrew 404, and has a plurality of ball grooves (or “threads”) 426 formed thereon. The ballscrew 404 is coupled to receive the rotational drive force from the motor 402 and, in response thereto, to rotate. In the depicted embodiment, an input gear 428 is coupled to the ballscrew outer surface 422, and receives the rotational drive force, via the above-mentioned gears, which in turn causes the ballscrew 404 to rotate. Although the input gear 428 is shown disposed substantially centrally between the ballscrew first 414 and second 416 ends, it will be appreciated that this is merely exemplary of a particular preferred embodiment, and that the input gear could be coupled to other locations on the ballscrew outer surface 422, or to either the ballscrew first end 414 or second end 416.

A plurality of roller bearing assemblies, which includes a first roller bearing assembly 432 and a second roller bearing assembly 434, are mounted within the actuator assembly housing 408 and are used to rotationally support the ballscrew 404 therein. Moreover, a thrust bearing assembly 436 is preferably disposed between the actuator housing assembly 408 and the ballscrew first end 414. The thrust bearing 436 transfers any axial force supplied to the ballscrew 404 to the actuator housing assembly 408.

The ballnut 406 is disposed at least partially within the ballscrew 404 and similarly includes a first end 438, a second end 442, an inner surface 444, and an outer surface 446. The ballnut 406 is mounted against rotation within the actuator housing assembly 408 and is configured, in response to rotation of the ballscrew, to translate axially within the ballscrew cylindrical passageway 424. It will be appreciated that the direction in which the ballnut 406 travels will depend on the direction in which the ballscrew 404 rotates. In the depicted embodiment, an anti-rotation shaft 448 is coupled to the actuator housing assembly 408 and engages the ballnut 406 to prevent its rotation. It will be appreciated that the anti-rotation shaft 448 and ballnut 406 may be configured in any one of numerous ways to prevent ballnut rotation. In the depicted embodiment, the anti-rotation shaft 448 is disposed at least partially within a groove (not shown) formed in a portion of the ballnut inner surface 444, to thereby prevent its rotation.

As FIG. 4 additionally shows, the ballnut 406, similar to the ballscrew 404, has a plurality of ball grooves (or “threads”) 452 formed therein. However, unlike the ballscrew ball grooves 426, the ballnut ball grooves 452 are formed in the ballnut outer surface 446. A plurality of balls 454 are disposed within the ballnut ball grooves 452, and in selected ones of the ballscrew ball grooves 426. The balls 454, in combination with the ball grooves 426, 452, convert the rotational movement of the ballscrew 404 into the translational movement of the ballnut 406. As FIG. 4 additionally shows, a pad 443 is coupled to the ballnut second end 442. The pad 443 engages an aircraft brake element (not shown) when the brake actuator 108 is commanded to an engage position.

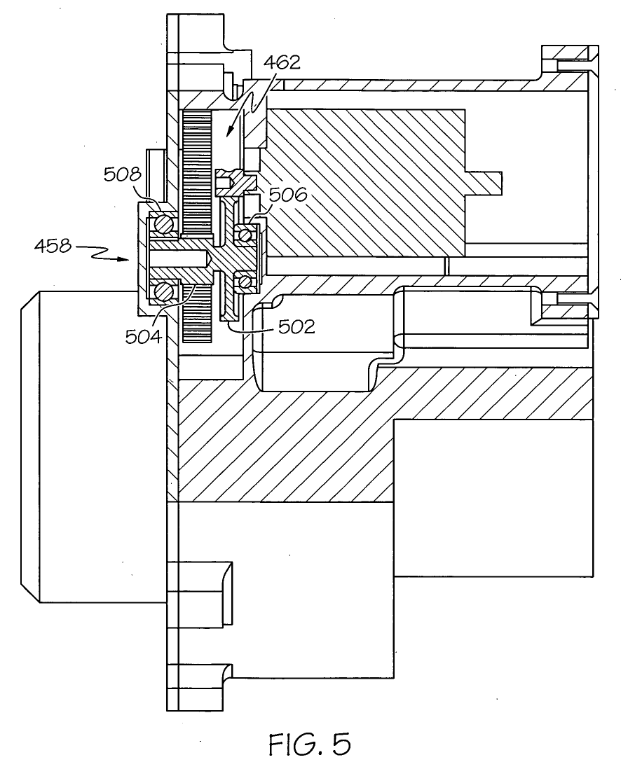

As was mentioned above, the rotational drive force of the motor 402 is supplied to the ballscrew 404 via a plurality of gears. In the depicted embodiment, the gears include a motor output gear 456, a first intermediate gear set 458, a second intermediate gear set 462, and the ballscrew input gear 428. More specifically, and with reference now to FIG. 5, it is seen that the motor output gear 456 is coupled to the motor 402, and engages the first intermediate gear set 458. Thus, the motor output gear 456 receives the rotational drive force directly therefrom, and causes the first intermediate gear set 458 to rotate in response thereto.

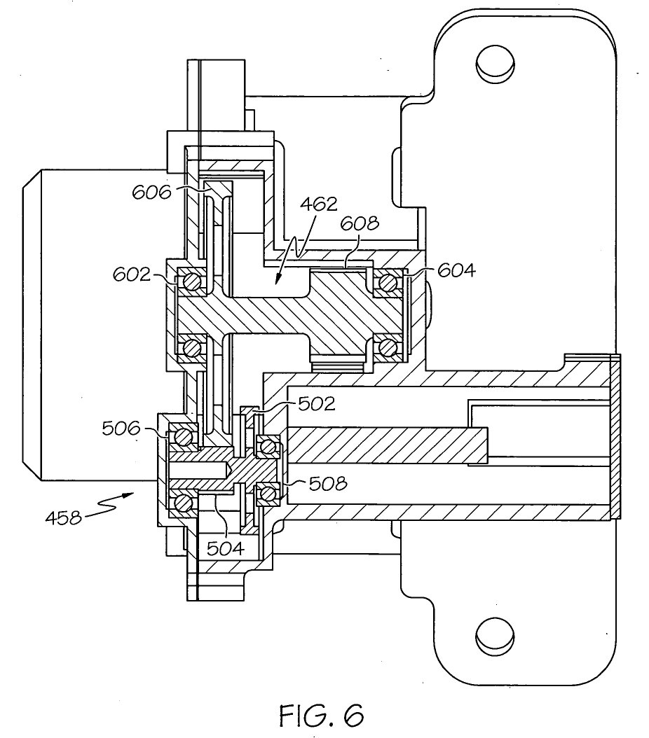

With continued reference to FIG. 5, it is seen that the first intermediate gear set 458 includes two gears, an input gear 502 and an output gear 504, and is rotationally mounted within the actuator housing assembly 408 via third and fourth roller bearing assemblies 506 and 508, respectively. The first intermediate gear set input gear 502 engages the motor output gear 456 and, as shown more clearly in FIG. 6, the first intermediate gear set output gear 504 engages the second intermediate gear set 462.

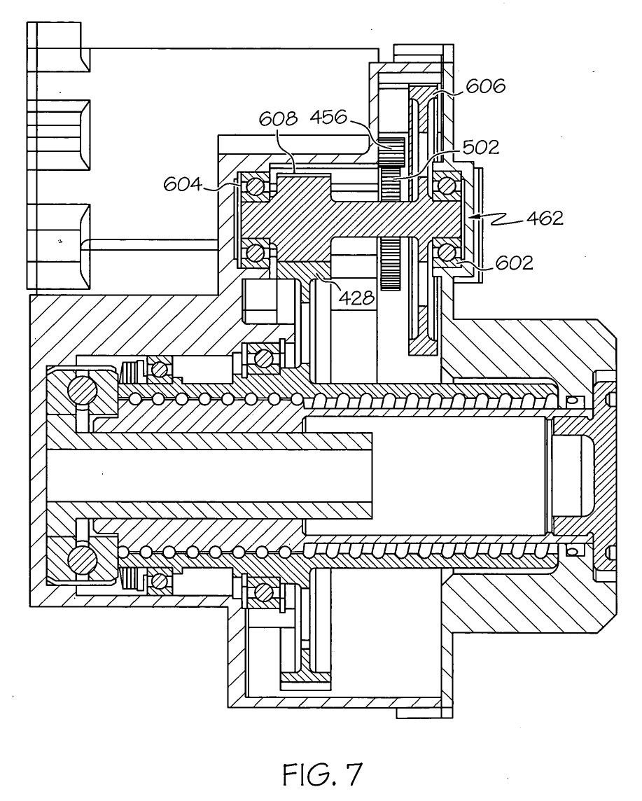

The second intermediate gear set 462, similar to the first intermediate gear set 458, is rotationally mounted and includes two gears. More specifically, and with continuing reference to FIG. 6, it is seen that the second intermediate gear set 462 is rotationally mounted in the actuator housing assembly 408 via fifth and sixth roller bearing assemblies 602 and 604, respectively, and includes an input gear 606 and an output gear 608. The second intermediate gear set input gear 606 engages the first intermediate gear set output gear 504 and, as shown most clearly in FIG. 7, the second intermediate gear set output gear 608 engages the ballscrew input gear 428.

With the above-described gear configuration, the first intermediate gear set 458 receives, via the motor output gear 456, the rotational drive force supplied by the motor 402. As a result, the first intermediate gear set 458 rotates, and supplies the rotational drive force to the second intermediate gear set 462. In turn, the second intermediate gear set 462 rotates and supplies the rotational drive force to the ballscrew input gear 428, which causes the ballscrew 404 to rotate. It will be appreciated that the gear ratio between the motor output gear 456 and the first intermediate gear set input gear 502 provides a first rotational speed reduction, and the gear ratio between the first intermediate gear set output gear 504 and the second intermediate gear set 462 provides a second rotational speed reduction. It will be appreciated that the individual and/or collective gear ratios and the concomitant individual and/or collective rotational speed reductions may vary to achieve a desired torque-speed characteristic for the brake actuator 108.

The brake actuator system 100 described above includes a brake actuator 108 having a ballscrew 404 that surrounds at least a portion of a ballnut 406. The ballscrew 404 has ball grooves 426 formed on its inner surface 418, the ballnut 406 has ball grooves 452 formed on its outer surface 446, and a plurality of balls 454 are disposed in the ballnut ball grooves 452 and a portion of the ballscrew ball grooves 426. This preferred configuration provides a ballscrew-type actuator assembly that has a relatively higher capacity, and a shorter overall length, as compared to presently known configurations, and does not include any surfaces that both translate and rotate that need to be sealed.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An aircraft brake actuation system, comprising:
a control circuit configured to selectively supply brake force motor command signals representative of a commanded brake force;
a motor coupled to receive the brake force motor command signals from the control circuit and operable, in response thereto, to supply a rotational drive force; and
an actuator coupled to receive the rotational drive force from the motor and configured, upon receipt thereof, to move to a position that corresponds to the commanded brake force, the actuator including:
an actuator housing,
a ballscrew rotationally mounted within the actuator housing and including at least an inner surface, the ballscrew inner surface having a plurality of ball grooves formed thereon, the ballscrew coupled to receive the rotational drive force from the motor and configured, in response thereto, to rotate;
a ballnut mounted against rotation and disposed at least partially within the ballscrew, the ballnut including at least an inner surface and an outer surface, the ballnut outer surface having a plurality of ball grooves formed thereon; and
a plurality of balls disposed within the ballnut ball grooves and at least selected ones of the ballscrew ball grooves,
wherein rotation of the ballscrew causes translation of the ballnut.

2. The system of claim 1, further comprising:
an anti-rotation shaft coupled to the actuator housing, the anti-rotation shaft disposed at least partially within, and configured to prevent rotation of, the ballnut.

3. The system of claim 2, wherein the anti-rotation guide engages at least a portion of the ballnut inner surface to thereby prevent rotation thereof.

4. The system of claim 1, further comprising:
a plurality of bearing assemblies coupled between the actuator housing and the ballscrew outer surface, bearing assemblies configured to rotationally mount the ballscrew within the actuator housing.

5. The system of claim 1, wherein the ballscrew further includes a first end and a second end, and wherein the actuator assembly further comprises:
a thrust bearing coupled between the actuator housing and the ballscrew first end.

6. The system of claim 1, wherein the ballnut further includes a first end and a second end, and wherein the actuator assembly further comprises:
a pad coupled to the ballnut second end, the pad configured to engage an aircraft brake element.

7. The system of claim 1, wherein the motor is a brushless DC motor.

8. The system of claim 1, wherein the motor is mounted at least partially within the actuator housing.

9. The system of claim 8, further comprising:
a plurality of gears coupled between the motor and the ballscrew, the gears configured to receive the rotational drive force supplied by the motor and transfer the rotational drive force to the ballscrew.

10. The system of claim 9, wherein the motor and the plurality of gears are each at least partially mounted within the actuator housing.

11. An actuator assembly, comprising:
a housing;
a motor configured to supply a rotational drive force;
a ballscrew rotationally mounted within the housing and including at least an inner surface and an outer surface, the ballscrew inner surface having a plurality of ball grooves formed thereon, the ballscrew adapted to receive the rotational drive force from the motor and configured, in response thereto, to rotate;
a ballnut mounted against rotation and disposed at least partially within the ballscrew, the ballnut including at least an inner surface and an outer surface, the ballnut outer surface having a plurality of ball grooves formed thereon; and
a plurality of balls disposed within the ballnut ball grooves and at least selected ones of the ballscrew ball grooves,
wherein rotation of the ballscrew causes translation of the ballnut.

12. The actuator assembly of claim 11, further comprising:
an anti-rotation shaft coupled to the housing, the anti-rotation shaft disposed at least partially within, and configured to prevent rotation of, the ballnut.

13. The actuator assembly of claim 12, wherein the anti-rotation shaft engages at least a portion of the ballnut inner surface to thereby prevent rotation thereof.

14. The actuator assembly of claim 11, further comprising:
a plurality of bearing assemblies coupled between the housing and the ballscrew outer surface, bearing assemblies configured to rotationally mount the ballscrew within the housing.

15. The actuator assembly of claim 11, wherein the ballscrew further includes a first end and a second end, and wherein the actuator assembly further comprises:
a thrust bearing coupled between the housing and the ballscrew first end.

16. The actuator assembly of claim 11, wherein the ballnut further includes a first end and a second end, and wherein the actuator assembly further comprises:
a pad coupled to the ballnut second end, the pad configured to engage an aircraft brake element.

17. The actuator assembly of claim 11, wherein the motor is a brushless DC motor.

18. The actuator assembly of claim 11, wherein the motor is mounted at least partially within the housing.

19. The actuator assembly of claim 11, further comprising:
a plurality of gears coupled between the motor and the ballscrew, the gears configured to receive the rotational drive force supplied by the motor and transfer the rotational drive force to the ballscrew.

20. The actuator assembly of claim 19, wherein the motor and the plurality of gears are each at least partially mounted within the housing.

21. An actuator, comprising:
a housing;
a ballscrew rotationally mounted within the housing and including at least an inner surface and an outer surface, the ballscrew inner surface having a plurality of ball grooves formed thereon, the ballscrew adapted to receive a rotational drive force and configured, upon receipt thereof, to rotate;
a ballnut mounted against rotation and disposed at least partially within the ballscrew, the ballnut including at least an inner surface and an outer surface, the ballnut outer surface having a plurality of ball grooves formed thereon;
a plurality of balls disposed within the ballnut ball grooves and at least selected ones of the ballscrew ball grooves,
wherein rotation of the ballscrew causes translation of the ballnut.

22. The actuator assembly of claim 21, further comprising:
an anti-rotation shaft coupled to the housing, the anti-rotation shaft disposed at least partially within, and configured to prevent rotation of, the ballnut.

23. The actuator assembly of claim 22, wherein the anti-rotation guide engages at least a portion of the ballnut inner surface to thereby prevent rotation thereof.

24. The actuator assembly of claim 21, further comprising:
a plurality of bearing assemblies coupled between the housing and the ballscrew outer surface, bearing assemblies configured to rotationally mount the ballscrew within the housing.

25. The actuator assembly of claim 21, wherein the ballscrew further includes a first end and a second end, and wherein the actuator assembly further comprises:
a thrust bearing coupled between the housing and the ballscrew first end.

26. The actuator assembly of claim 21, wherein the ballnut further includes a first end and a second end, and wherein the actuator assembly further comprises:
a pad coupled to the ballnut second end, the pad configured to engage an aircraft brake element.

27. The actuator assembly of claim 21, further comprising:
a motor coupled to the ballscrew outer surface and configured to supply the rotational drive force thereto.

28. The actuator assembly of claim 27, wherein the motor is a brushless DC motor.

29. The actuator assembly of claim 28, wherein the motor is mounted at least partially within the housing.

30. The actuator assembly of claim 27, further comprising:
a plurality of gears coupled between the motor and the ballscrew, the gears configured to receive the rotational drive force supplied by the motor and transfer the rotational drive force to the ballscrew.

31. The actuator assembly of claim 30, wherein the motor and the plurality of gears are each at least partially mounted within the housing.
